(19) United States
(12) Patent Application Publication
(10) Pub. No.: US 2026/0189061 A1
(43) Pub. Date: Jul. 2, 2026

(54) GRID INTERFACE POWER MANAGEMENT

(71) Applicant: PowerFlex Systems, LLC, San Diego, CA (US)

(72) Inventors: Ryan HENLEY, San Francisco, CA (US); Kyle GEORGESON, Reno, NV (US)

(21) Appl. No.: 19/427,104

(22) Filed: Dec. 19, 2025

Related U.S. Application Data
(60) Provisional application No. 63/740,251, filed on Dec. 30, 2024.

(51) Int. Cl. H02J 13/12; H02J 3/007; H02J 3/38

(52) U.S. Cl. CPC H02J 13/12; H02J 3/007; H02J 3/38

(57) ABSTRACT

Certain aspects of the present disclosure provide techniques for site control. An example method includes obtaining a plurality of power measurements from one or more site energy sources and one or more points of common coupling associated with the one or more site energy sources, wherein the one or more points of common coupling correspond to one or more nodes where the one or more site energy sources are coupled to a grid; determining whether the plurality of power measurements violate a grid limit of the grid for at least a threshold time period; and sending a trip signal to at least one inverter controller associated with at least one site energy source of the one or more site energy sources based on the plurality of power measurements violating the grid limit for at least the threshold time period.

### CROSS-REFERENCE TO RELATED APPLICATIONS

This Application claims the benefit of and priority to U.S. Provisional Application No. 63/740,251 , filed on Dec. 30, 2024, the entire contents of which are hereby incorporated by reference.

### INTRODUCTION

Many types of power networks are connected to a utility grid to receive electricity or send back electricity. One example of such power networks may include an electric vehicle (EV) charging infrastructure. EV charging infrastructure (as well as other types of power networks) is a rapidly evolving field given the popularity of EVs and other energy resources that use or generate electricity. Certain examples are discussed with respect to EV charging infrastructure for ease of illustration, but it should be noted that the concepts herein may be applied to other types of power networks. EV charging stations such as electric vehicle supply equipments (EVSEs) often rely on backend systems (e.g., local and/or cloud-based backend systems) to manage charging sessions. For example, when an EV connects to an EVSE, the EVSE sends a status update to a backend system, which then initiates and manages a charging session. The backend system maintains databases of active charging sessions across multiple sites and EVSEs. As the EV charging infrastructure evolves, an increasing number and/or type of energy assets that support these sites and EVSEs may lead to an increased level of complexity in how such energy assets are managed and controlled. The increased level of complexity in the management and control of the energy assets may be associated with various types of technical challenges. Accordingly, there exists a need for improvements in EV charging infrastructure to overcome these technical challenges. As the EV charging infrastructure continues to expand, such technical challenges are expected to affect more users.

### SUMMARY

Certain aspects provide a method for site control. In some aspects, the method includes obtaining a plurality of power measurements from one or more site energy sources and one or more points of common coupling associated with the one or more site energy sources, wherein the one or more points of common coupling correspond to one or more nodes where the one or more site energy sources are coupled to a grid; determining whether the plurality of power measurements violate a grid limit of the grid for at least a threshold time period; and sending a trip signal to at least one inverter controller associated with at least one site energy source of the one or more site energy sources based on the plurality of power measurements violating the grid limit for at least the threshold time period.

In some aspects, the method includes: obtaining a plurality of power measurements from one or more site energy sources and one or more points of common coupling associated with the one or more site energy sources, wherein the one or more points of common coupling correspond to one or more nodes where the one or more site energy sources are coupled to a grid; obtaining one or more operational parameters for the one or more site energy sources; determining one or more adjusted operational parameters for the one or more site energy sources based on the one or more operational parameters, the plurality of power measurements, and a grid limit of the grid; and sending the one or more adjusted operational parameters to one or more inverter controllers associated with the one or more site energy sources.

Other aspects of the present disclosure provide one or more processing systems configured to perform the aforementioned methods as well as those described herein; one or more non-transitory, computer-readable mediums comprising instructions that, when executed by one or more processors of one or more processing systems, cause the one or more processing systems to perform the aforementioned methods as well as those described herein; a computer program product embodied on a computer readable storage medium comprising code for performing the aforementioned methods as well as those described herein; and a processing system comprising means for performing the aforementioned methods as well as those described herein.

The following description and the related drawings set forth in detail certain illustrative features of one or more aspects.

### DESCRIPTION OF THE DRAWINGS

The aspects set forth in the drawings are illustrative and exemplary in nature and not intended to limit the disclosure. The following detailed description of the illustrative aspects can be understood when read in conjunction with the following drawings, where like structure is indicated with like reference numerals and in which:

FIG. 1 depicts an example computing environment for site control for grid interface power management, according to aspects provided herein;

FIG. 2 depicts a software configuration for an example edge environment for site control for grid interface power management, according to aspects provided herein;

FIGS. 3A-3C depict example device configurations for an edge environment for site control for grid interface power management, according to aspects provided herein;

FIGS. 4A-4C depict example hardware components that may be utilized for the devices from FIGS. 3A-3C, according to aspects provided herein;

FIG. 5 depicts a software configuration for an example cloud environment which may interact with an example site control system, according to aspects provided herein;

FIG. 6 depicts an example site environment having a system for site control for grid interface power management, according to aspects provided herein;

FIG. 7 depicts an example process flow for a site control system for grid interface power management, according to aspects provided herein;

FIG. 8 depicts a method for site control for grid interface power management, according to aspects provided herein;

FIG. 9 depicts another method for site control for grid interface power management, according to aspects provided herein; and

FIG. 10 depicts an example processing system configured to perform the methods described herein.

### DETAILED DESCRIPTION

Aspects disclosed herein include systems and methods for site control for grid interface power management. Some aspects utilize a site control system that acts as or has, at least in part, an inverter agnostic grid limiter which utilizes (e.g., fast-read) protocols of power meters to (e.g., continuously) enforce power limits of on-site energy assets or resources. Aspects of systems and methods for site control for grid interface power management, incorporating the same, will be described in more detail, below. Certain aspects may be discussed with respect to an EV charging infrastructure, but it should be understood that the techniques discussed herein are also applicable to other types of power networks.

A site energy source, such as battery energy storage systems (BESSs), photovoltaic (PV) energy systems (e.g., including solar panels), wind energy system (e.g., including wind turbines), hydro energy systems, or the like, is capable of supplying energy to various loads (e.g., EVSEs) that may be coupled to the site energy source. For example, the site energy source may be local to a site and provide energy to loads within the site. The site may further be coupled to a utility grid (which is also referred to herein as a grid) configured to also supply energy to loads within the site, as well as other sites. Accordingly, the site may be able to draw energy from the site energy source and the utility grid, as needed. The point where the utility grid connects to the site may be referred to as a point of common coupling (PCC), which may be the point where the site energy source and loads of the site couple to the utility grid.

In some cases, the site energy source itself may be capable of importing energy from the utility grid. The rate of import of energy may be referred to as the import power. For example, a BESS may utilize energy from the utility grid to charge one or more batteries to store energy for later use.

In some cases, the site energy source itself may be capable of exporting energy to the utility grid. The rate of export of energy may be referred to as the export power. For example, any site energy source may supply energy to the utility grid, such as for use by other sites.

In many cases, a utility grid may impose one or more grid limits that regulate the importation and exportation of energy, such as based on the rate of energy transfer, such as the import power and export power from and to the grid. For example, a minimum power import limit may regulate a minimum power level for import of energy from the utility grid (e.g., over a time period) at the PCC of the site in order to be able to export energy at a certain export power level from a battery to the utility grid. A non-power export limit may forbid exportation of energy from any site energy source to the utility grid, such that export power limit may be zero. A limited-power export limit may define a specified export power limit at which the site can export energy to the utility grid (e.g., over a time period). A non-power import limit may forbid importation of energy from the utility grid, at any import power level, to charge a battery at the site, or similar. For example, the import power level limit may be zero for battery charging.

A technical problem associated with the one or more grid limits, is how to ensure that the site energy sources of a site operate in a manner that does not violate the one or more grid limits (e.g., import power limits, export power limits, etc.), or at least does not violate the one or more grid limits for more than a threshold amount of time (e.g., 2 seconds).

A solution to the grid limit violation problem is to utilize one or more protection relays that are designed in hardware to trip and disconnect an energy source from the PCC to stop the energy source from being able to import and export energy at any power level from and to the utility grid when a violation is determined. An issue with use of such protection relays is that they are complex to set up.

Another solution to the grid limit violation problem is to design each individual inverter of each site energy source to be capable of monitoring its import and/or export power levels with respect to the utility grid, and of controlling such import and/or export power levels so as to avoid a grid limit violation. This may not be feasible in scenarios where there are existing inverters in a site that do not have such capability, and may require more complex hardware design at each individual inverter.

Accordingly, certain aspects discussed herein provide a site controller configured to obtain power measurements for a site (e.g., revenue grade power meter with digital inputs and digital outputs) and control one or more site energy sources of the site so as to avoid a grid limit violation. In certain aspects, such site controller may be capable of monitoring and controlling multiple site energy sources, such as multiple inverters of multiple site energy sources, which may simplify the design of each individual site energy source and avoid the complexity of a protection relay design discussed above.

In certain aspects, the site controller is configured to obtain power measurements from one or more site energy sources and the PCC of the site, such as to determine whether a grid limit violation has occurred or is likely to occur. In some cases, the power measurement from the one or more site energy sources and the power measurement from the PCC of the site may be different or separate, such as when some energy may be consumed on-site.

In certain aspects, the site controller is configured to determine whether based on the power measurements, a grid limit violation has occurred, or may be likely to occur. For example, the site controller may determine current operational parameters (e.g., charge rate, discharge rate, energy production rate, duty cycle, on duration, off duration, etc.) for a site energy source, and determine that if the site energy source continues to operate based on the current operational parameters, in view of the current power measurements, a grid limit violation will occur. Accordingly, the site controller may adjust the operational parameters (e.g., reduce power output level) for the site energy source, and send the adjusted operational parameters to the site energy source (e.g., an inverter of the site energy source, which may be controlled by an inverter controller) to avoid the grid limit violation. This may provide a technical solution to the technical problem of how to avoid a grid limit violation, such as without the complexity of a protection relay design discussed above.

In certain aspects, the site controller is configured to send a trip signal to any site energy source the site controller determines is in violation of a grid limit (e.g., is in violation of the grid limit for at least a threshold time period, such as 2 seconds). Based on the trip signal, the site energy source, such as an inverter of the site energy source, may stop importing or exporting any energy, such that the import power level and/or export power level is zero. Such trip signal, therefore, may provide the advantage of a fail-safe to avoid long-term violations of a grid limit, such as when setting operational parameters for a site energy source may take longer to take effect to bring power levels below the grid limit.

### Example Computing Environment

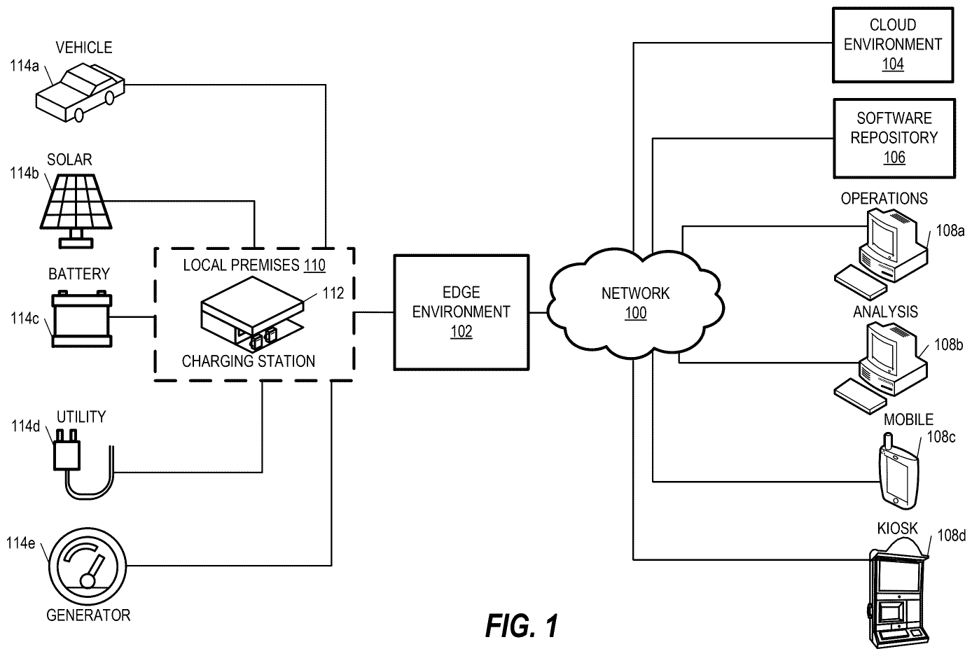

Referring now to the drawings, FIG. 1 depicts an example computing environment for site control (e.g., for grid interface power management), according to aspects provided herein. As illustrated, the computing environment includes a network 100 that is coupled to an edge environment 102, a cloud environment 104, a software repository 106, as well as one or more ancillary devices 108 (including an operations device 108a, an analysis device 108b, a mobile device 108c, and/or a kiosk device 108d). The network 100 may be configured as any wide area network (WAN, such as the internet, power network, cellular network, etc.) or other network for facilitating communication among the edge environment 102, the cloud environment 104, the software repository 106, and the ancillary devices 108.

Edge environment 102 may generally be deployed at a local premises site 110 (also referred to herein as a site) to provide various services, including coordination and optimization of one or more energy assets 114 (including an EV 114a, a solar device 114b, a BESS 114c, a utility grid 114d, and/or a generator 114e), such as charging of electric vehicles (e.g., EV 114a) using charging station 112 and controlling one or more of various distributed energy resources (DERs), such as solar device 114b, BESS 114c, utility grid 114d, and/or generator 114e (e.g., an on-site diesel, natural gas, or other type of fueled generator). The aforementioned DERs may provide energy to the charging station 112 and/or use energy from the charging station 112 (e.g., by way of a backflow of energy from EV 114a to other aspects of site 110). In some aspects, charging station 112 may send excess energy back to the BESS 114c and/or to utility grid 114d. In certain aspects, site 110 may only have certain ones (e.g., a subset) of the types of energy assets, rather than all that is described herein. As one example, site 110 may not include any charging station 112. In some aspects, edge environment 102 may monitor and/or modify the energy sent to and received from the DERs to optimize various tasks, such as charging of EV 114a.

Charging station 112 may utilize one or more of various communication protocols, such as open smart charging protocol (OSCP), open charge point interface (OCPI), ISO 15118, OpenADR, open charge point protocol (OCPP), etc. and may represent Level 1, Level 2, Level 3 (e.g., DC Fast Charging), and higher level charging stations, as applicable. Generally, the “level” of a charging station refers to the power level and/or ability to provide electric power to a device being charged.

Edge environment 102 is configured as an interface between various aspects of site 110 and network 100. In various aspects, compute resources for performing different functions at a site, such as control or optimization of EV charging, may be split between local compute resources in edge environment 102 and remote compute resources, e.g., in cloud environment 104 of FIG. 1.

Cloud environment 104 is coupled to the edge environment 102 via the network 100 and may be configured for further processing of data, as described herein. While FIG. 1 depicts a single cloud environment 104 that serves a single edge environment 102, this is merely an example, as some aspects may be configured such that the cloud environment 104 may serve a plurality of edge environments 102 that each serve one or more sites 110, one or more charging stations 112, one or more DERs, and the like.

Software repository 106 is also coupled to site 110 via network 100. Software repository 106 may be configured as a platform to program, store, manage, control changes, etc. to software that is implemented in edge environment 102 and/or cloud environment 104. In some aspects, software repository 106 may be configured as a proprietary service and/or may be provided by a third-party, such as GitHub™. Additionally, some aspects may be configured such that the software repository 106 is provided by the same entity that manages the cloud environment 104. As such, these aspects may be configured such that software repository 106 and cloud environment 104 may be combined.

With respect to the ancillary devices 108, the operations device 108a may be utilized to monitor and/or alter operations of the computing environment provided in FIG. 1. The analysis device 108b may analyze utilization, operation, charging, and/or other features of the computing environment provided in FIG. 1. The mobile device 108c may represent an administrator device and/or a user device. As a user device, the mobile device 108c may initiate charging, perform payment, and/or perform other user-specific actions. As an administrator device, the mobile device 108c may perform administrative operations, analysis, and/or other actions. The kiosk device 108d may be located at one of the charging stations 112 and/or remote therefrom and may provide user-specific or administrative actions, similar to that of the mobile device 108c. In some aspects, one or more administrators may use the kiosk device 108d to view information about a site or make changes. As will be understood by one of ordinary skill in the art, the ancillary devices 108 may each include one or more processors, one or more memory components, and/or other hardware and/or software for performing the functionalities provided herein. It should be understood that while the kiosk device 108d is depicted as being remote from the site 110, some aspects may not be configured in this manner. Specifically, some aspects may utilize a kiosk device 108d that is local at the site 110, which may communicate via a local network and/or the network 100 for providing the services described herein.

### Example Edge Environment

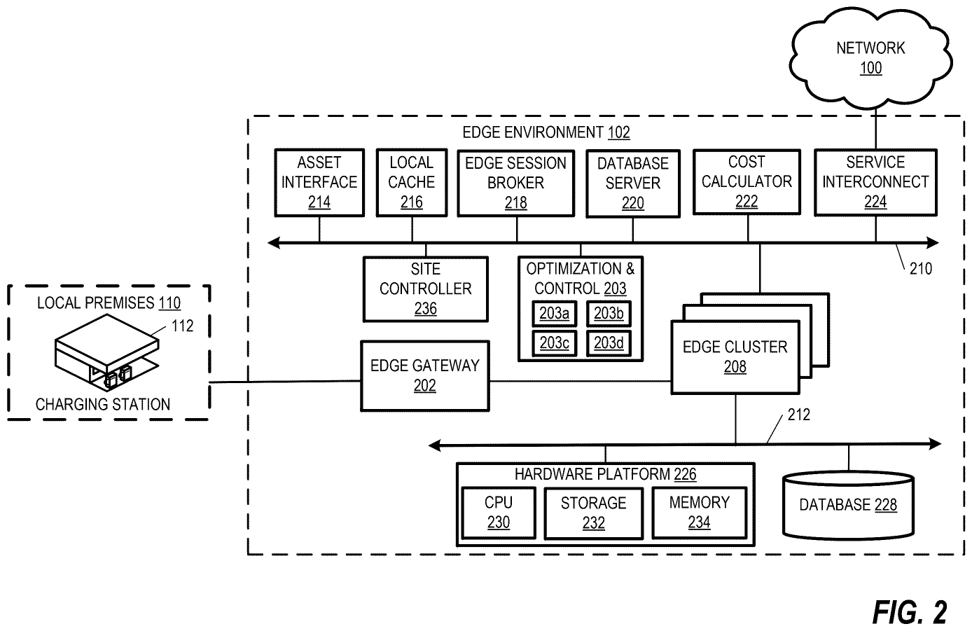

Referring now to FIG. 2, the edge environment 102 may be coupled to the site 110 via an edge gateway 202. Edge environment 102 may be operatively coupled to aspects of site 110, such as charging station 112 via edge gateway 202. Edge environment 102 further includes an edge cluster 208, which is coupled to communication bus 210 and hardware bus 212. Communication bus 210 is coupled to optimization and control manager 203, asset interface 214, local cache 216, edge session broker 218, database server 220, cost calculator 222, and service interconnect 224 in this example. In certain aspects, communication bus 210 is also coupled to a site controller component 236 (e.g., server, for grid interface power management). Hardware bus 212 is coupled to hardware platform 226, which may include one or more processors, such as CPU 230, one or more storage components 232, one or more memory components 234, and/or other hardware components. Also coupled to hardware bus 212 is database 228. Though certain components (e.g., cost calculator 222, database server 220, etc.) of edge environment 102 are depicted separate from hardware platform 226, they may be services or processes configured to run on hardware platform 226. Further, though certain components are illustrated as separate components, the functionality of such components may be combined into a single component and/or further divided among additional components.

Communication bus 210 and hardware bus 212 may be utilized to facilitate operation of all services that run in edge environment 102 and communicate with each other via a distributed message streaming system. The coupling of the aforementioned services may be accomplished in some aspects via a distributed message streaming system, such as NATS.

In the depicted example, charging station 112 is configured for communication with edge environment 102 via edge gateway 202, such as via a short-range wireless network technology, such as via a Zigbee® PAN. The edge gateway 202 may be configured to receive data, such as electric vehicle charging data, price change data, vehicle data, etc. from the charging station 112 and/or vehicles that are being charged via the connection with the site 110 (of FIG. 1).

In some aspects, edge gateway 202 may be configured to abstract data received from various aspects of site 110 (of FIG. 1), such as charging station 112, to remove protocol-specific distinctions. For example, a first charging station may utilize a first communication protocol and/or billing protocol and a second charging station may utilize a second communication protocol and/or billing protocol. Edge gateway 202 may receive data packets from both the first charging station using the first communication protocol and the second charging station using the second communication protocol and may transform the received data into a protocol-agnostic format prior to providing the data to edge cluster 208. This may allow wide interoperability between edge environment 102 and various types of hardware (e.g., charging station 112) at a site.

Edge cluster 208 is the central message center in various aspects. For example, when a user plugs a vehicle into a charging station 112, edge cluster 208 receives data from edge gateway 202, parses that data (e.g., to generate access state data) and causes the state data to be sent to the database server 220. Edge cluster 208 also receives the data and creates a session entry, which may be stored in the local cache 216. Edge cluster 208 may additionally send the session entry to the cloud environment 104 (of FIG. 1) via network 100. Edge session broker 218 may also receive data related to the new session and may query database server 220 to access additional session data to determine charging characteristics for charging station 112.

The edge session broker 218 may produce data or signals that are sent to the edge cluster 208, which may be sent to the edge gateway 202 for potentially sending back to one or more of the charging stations 112. Information that may be reported might include current delivered over time (e.g., amperes), total energy delivered (e.g., kWh), power delivered over time (e.g., kW), voltage at the charging station over time (e.g., V), charging station state (e.g., connected, disconnected, offline), connectivity state, charging state, etc. The charging stations 112 may report any errors back to the edge cluster 208. The cost calculator 222 may be engaged to access pricing data from the cloud environment 104 and may calculate costs incurred based on delivered energy, expected costs prior to charging, idle time interval, parking time interval, etc. The asset interface 214 may be a software interface between the edge environment 102 and the energy assets 114.

Edge cluster 208 may be configured such that any message received by the edge cluster 208 may also be sent to the cloud environment 104 (of FIG. 1) for consumption by a data subscriber in the cloud environment 104. For example, if a user of the mobile device 108c (in FIG. 1) desires to claim a charging session, mobile device 108c does not need to access edge environment 102 directly. Instead, mobile device 108c may connect with the cloud environment 104 (of FIG. 1), which sends a message to the edge cluster 208 with an instruction to claim the session. Service interconnect 224 is configured for establishing an HTTP, TCP, and/or other type of communication with the cloud environment 104 (of FIG. 1) via network 100.

The optimization and control manager 203 may provide energy optimization and adaptive load management (ALM) functions, for example, for various energy assets 114 at the site 110 (of FIG. 1). For example, the optimization and control manager 203 may be responsible for calculating set-points for each asset for the energy optimization and ALM amongst the energy assets 114 and providing data related to the calculated set-points to the asset interface 214. A set-point may be a value for a parameter (or a set of values for a set of parameters), such as a charging rate. In certain aspects, the optimization and control manager 203 may include a database layer 203a to store data related to site configurations; an orchestration layer 203b to gather data, trigger optimizations, and/or issue set-points (e.g., provide the calculated set-points to energy assets); an optimization layer 203c to formulate and solve optimization problems to calculate set-points; and/or a control layer 203d for higher frequency feedback based controls (e.g., for modifying set-points to respond to fast time-scale events).

Optimization and control manager 203 may determine when optimization set-points need to be updated. Examples of when optimization set-points need to be updated include, but are not limited to: (1) when a new energy asset is installed at a site, (2) when a new vehicle to be charged arrives at a site, (3) when a measured value such as load or generation changes, (4) when a system parameter such as the target energy for a vehicle is updated, (5) when an external event occurs (such as a demand response event), and/or (6) at a fixed cadence (e.g., every 5 minutes). When it is determined that the optimization set-points need to be updated, optimization and control manager 203 may collect data needed for optimization, including optimization configuration from the cloud environment 104 of FIG. 1 (which can also be cached at edge environment 102) and state information from edge environment 102 and/or cloud environment 104. Examples of the optimization configuration include, but are not limited to: network and equipment constraints, optimization parameters such as the precision and timeout settings, etc. In certain aspects, the state information from edge environment 102 and/or cloud environment 104 includes the states of the energy assets, as well as other state information including EV driver preferences, price signals, and grid signals. Further, optimization and control manager 203 may perform optimization to calculate new/updated set-points. In certain aspects, optimization and control manager 203 may (e.g., optionally) run a fast time-scale control loop which adjusts set-points in real-time in response to fast changing signals, such as building load, solar generation, or grid signals. In some aspects, the functionalities of the optimization and control manager 203 may be implemented, at least in part, within the cloud environment 104 (of FIG. 1).

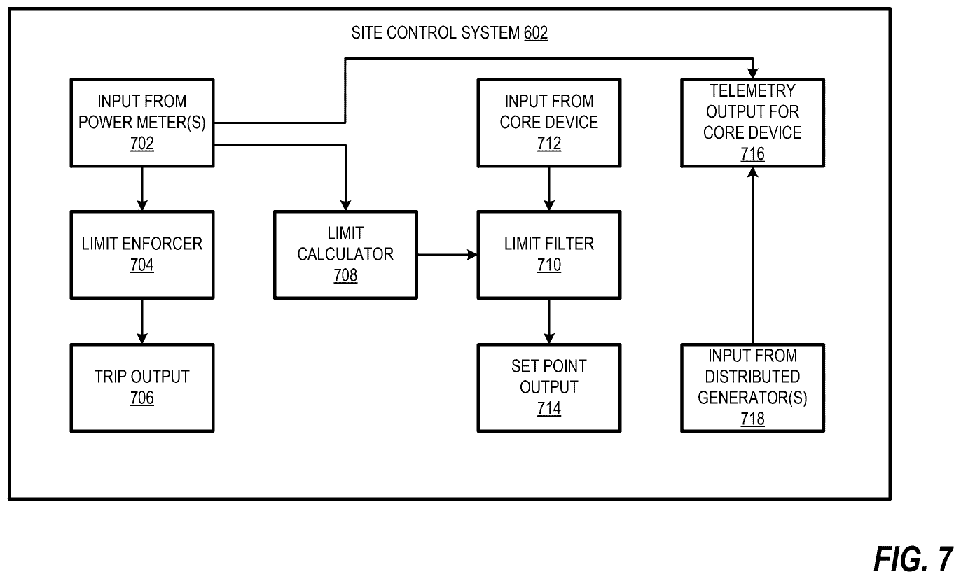

In certain aspects, the site controller component 236 (which, in some aspects, may exist physically and/or logically outside of the edge environment 102 and/or a piece of equipment within the edge environment 102) may implement one or more functions of a site control system that is described further herein with reference to, for example, FIG. 7 by utilizing one or more components of the edge environment 102 described herein (e.g., the optimization and control manager 203). In some aspects, the site control system may utilize one or more components and/or compute resources of the edge environment 102. In some aspects, the site control system may utilize data or information received from one or more components of the cloud environment 104 to implement its functions. For example, one or more components of the cloud environment 104 may be used to set one or more initial operational parameters for one or more site energy sources. In real time, however, the site control system may determine there is likely (e.g., within at least a threshold confidence) to be a grid limit violation, and accordingly, may modify those initial operational parameters (e.g., temporarily, as needed, etc.). Once the issue corresponding to a (e.g., likely) grid limit violation is no longer present, the one or more site energy sources may go back operating based on operational parameters as provided by the cloud environment 104 (which may or may not be updated by the cloud environment 104 in the meantime).

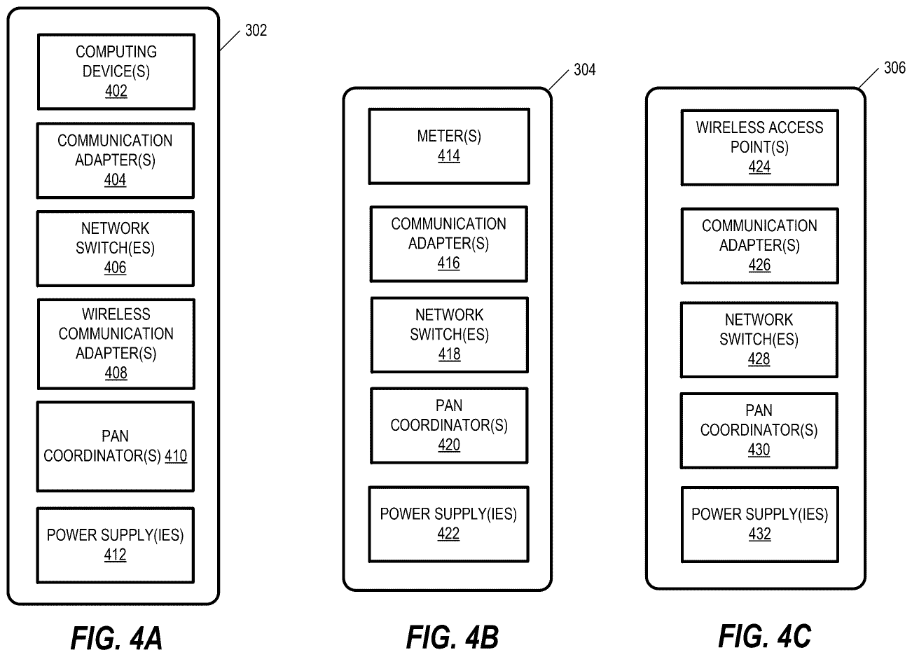

Hardware platform 226 represents any hardware for facilitating the processes and actions described herein. Specifically, one or more CPUs 230 may represent one or more types of processing device configured for executing instructions. One or more storage components 232 may be configured as long term storage, such as a hard drive or the like. One or more memory components 234 may include any of various types of random access memory or the like. One or more databases 228 may be configured for additional storage and may be housed with the other hardware and/or elsewhere. Examples of different hardware platforms that may be deployed in edge environment 102 are described further below with respect to FIGS. 4A-4C.

### Example Hardware Configurations for Edge Environment

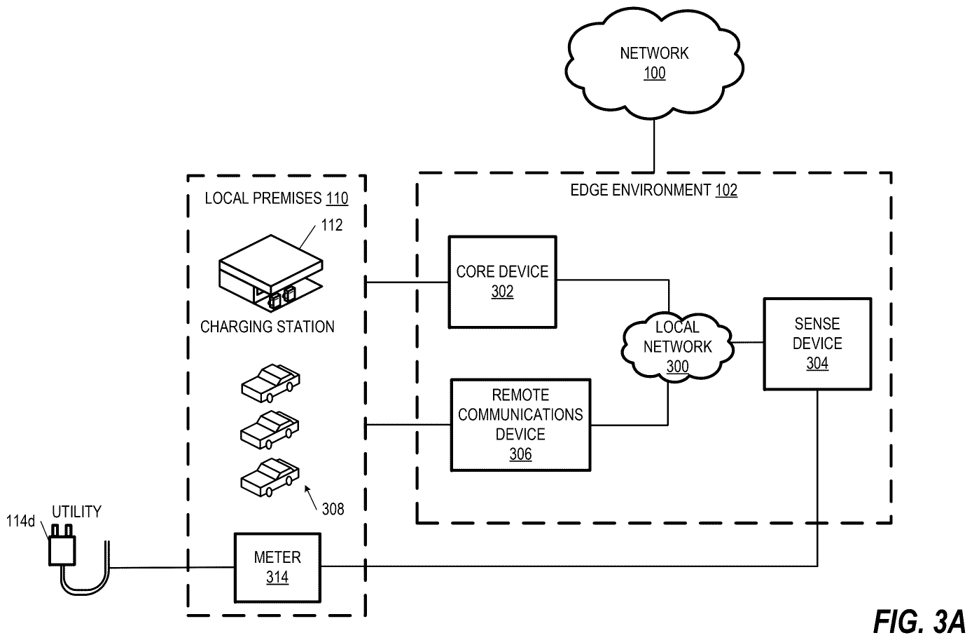

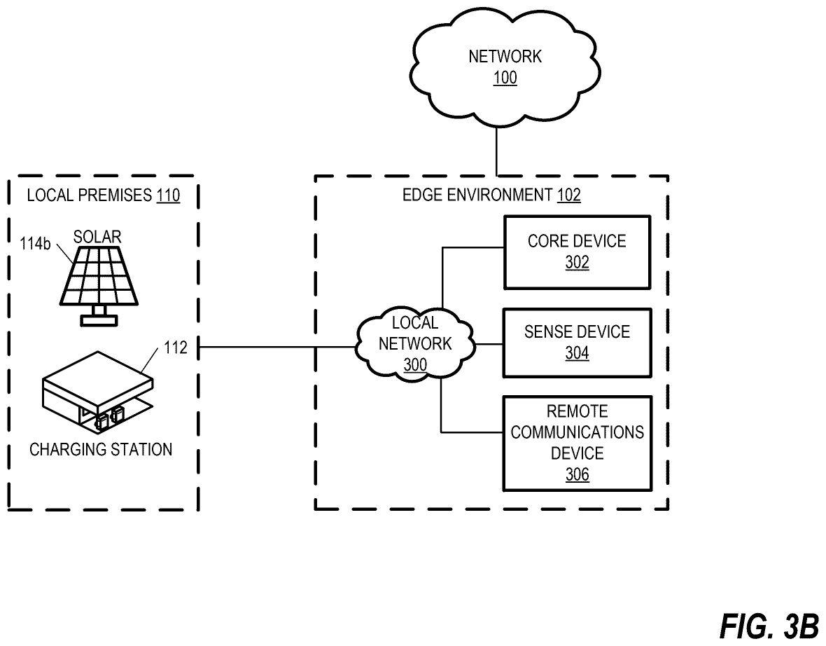

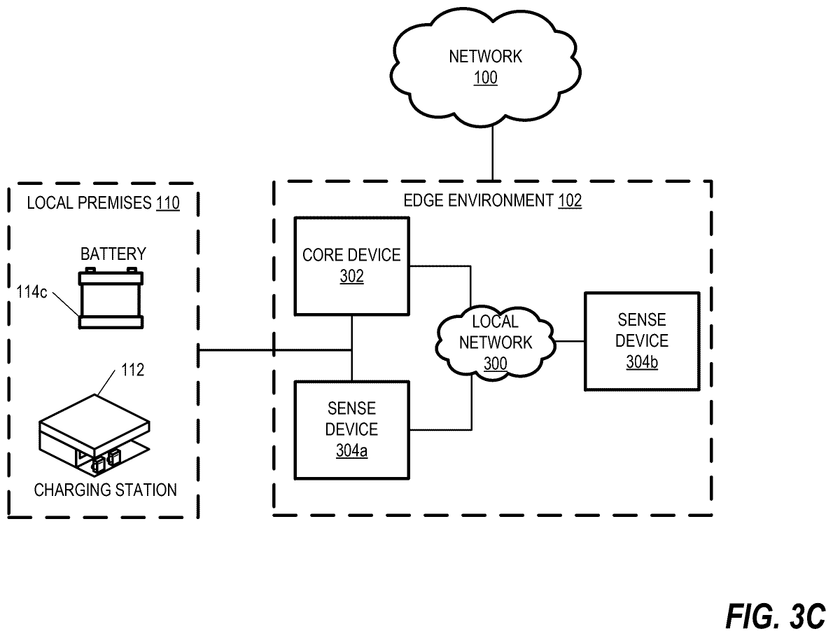

FIGS. 3A-3C depict example device configurations for edge environment 102, according to aspects provided herein. Specifically, FIG. 3A depicts a charging solution. As illustrated, the charging station 112 is coupled to a local network 300 via a core device 302. The local network 300 may include any local area network, Ethernet, PAN, etc. The core device 302 may be physically installed within communications range of one or more chargers in the charging station 112. A sense device 304 may be installed, for example, in an electrical room or in another enclosure with electrical equipment of the charging station 112 and/or one or more energy assets 114 to monitor the main metering point for the local utility point of common coupling. This may enable one or more algorithms to provide the optimal dispatch of EV charging power, subject to local energy rates and the vehicles currently charging. In the case that there are vehicles 308 using EV chargers that are out of communications range of the core device 302, such as a sub-level of a parking garage, one or more remote communications devices 306 may be included. In certain aspects, at least one of the one or more remote communications devices 306 may be in data communication with the charging station 112 (e.g., having one or more EV chargers charging one or more vehicles 308) and/or vehicles 308. Also included at the site 110 is a meter 314 for communicating energy with the utility grid 114d.

The core device 302 shown in FIG. 3A is the central processing device and serves as the communications hub. In certain aspects, the components of FIG. 2 may generally operate, at least in part, as part of the core device 302. The core device 302 may provide optimization, load management, communication coordination, site control (e.g., for grid interface power management) and/or data historian services. The core device 302 may communicate with the cloud environment 104 via cellular modem, wired internet service provider (ISP), and/or other communications medium to get current optimization and load management set-points for charging stations 112 and/or other assets, such as via an optimization algorithm that may be stored locally and/or at the cloud environment 104. It will be understood, however, that some aspects may be configured such that the core device 302 performs optimization locally. In certain aspects, the core device 302 dispatches these set-points, through a local communications protocol (e.g., Wi-Fi) and/or via the remote communications device 306 to reach locations that are distant or hard to reach, such as charging stations with a core device 302 and/or sense device 304 at sub-levels of a parking garage or a rooftop solar inverter. The core device 302 may additionally or alternatively collect data directly from distributed energy resources and power measurement devices or through cloud-based communications with the network 100.

Power and energy metering data may be collected via the sense device 304. The sense device 304 may include a smart meter with support for multiple single-and three-phase loads, such as with a local historian and Ethernet communication back to the device via the local network 300. The sense device 304 may also incorporate support for additional devices running on the edge including but not limited to thermocouple wiring, weather stations, temperature sensors, pyranometers, etc. It should be noted that additional sense devices 304 and remote communications devices 306 can be added to handle a variety of situations, such as a separate subpanel for energy metering of a new solar system or for monitoring of a new inverter associated with a rooftop solar installation.

FIG. 3B depicts a solar application where the core device 302 and the sense device 304 are installed in an electrical room or other common area. The sense device 304 can monitor the main metering point for the local utility as well as the solar production at tie-in breakers for the solar device 114b. The remote communications device 306 may be installed in a position to communicate directly with the solar device 114b and report the data received from the solar device 114b to the core device 302. Accordingly, the core device 302, the sense device 304, and the remote communications device 306 depicted in FIG. 3B may perform similar functions as those devices depicted in FIG. 3A.

FIG. 3C depicts a battery application where the core device 302 and the sense device 304 (including a first sense device 304a and a second sense device 304b) are installed physically near the BESS 114c. In some cases where the BESS 114c is near the point of common coupling with the utility grid 114d, a single sense device 304a can monitor the full site. In some cases where there is a significant distance to the metering point for the utility grid 114d, the second sense device 304b (or a plurality of second sense devices 304b) may be installed near the utility meter, such as the electrical room.

### Example Hardware Components in Core, Sense, and Remote Communications Devices

FIGS. 4A-4C depict example hardware that may be utilized for the devices from FIGS. 3A-3C, according to aspects provided herein. Specifically, FIG. 4A depicts hardware components that may be present in core device 302. In some aspects, the core device 302 is the brain where the energy optimization and adaptive load management (ALM) functions (e.g., by the optimization and control manager 203 of FIG. 2) and/or site control (e.g., for grid interface power management) are executed and dispatched. As illustrated, the core device 302 may include one or more computing devices 402, one or more communication adapters 404, one or more network switches 406, one or more wireless communication adapters 408, one or more PAN coordinators 410, and/or one or more power supplies 412. As will be understood, the computing device(s) 402 may include one or more processors, one or more memories, and/or other components that a conventional, specific-purpose machine may utilize. In some aspects, the computing device(s) 402 may include power line communication (PLC) infrastructure, while some aspects may utilize retail and/or micro-industrial computer components for optimization, load management, communication coordination, and/or historian services.

The communication adapter(s) 404 may be configured for load balancing and otherwise managing communications of, for example, Modbus RTU (RS485) to Modbus TCP (Ethernet) or Ethernet IP (RJ45) to Ethernet Optical (SFP), etc. The network switch(es) 406 may be configured for routing of network traffic, and may be configured as an Ethernet switch for communication to other nodes (e.g., the sense device 304, the remote communications device 306, and/or other core device 302), distributed energy resources, and/or energy based management systems.

The wireless communication adapter(s) 408 may include a cellular modem, internet modem, Wi-Fi access point, etc. for facilitating wireless communications to the internet or other wide area network. Similarly, the PAN coordinator(s) 410 may be configured to create and/or join communication connections with other devices. This may include a Zigbee coordinator, Bluetooth device, and/or other device for performing this function. The power supply(ies) 412 may be configured as battery power, connection to external power, etc.

FIG. 4B depicts hardware components of the sense device 304 from FIGS. 3A-3C. The sense device 304 may be configured as a smart-metering piece for collection and storage of power/energy data such as measurements such as temperature, voltage, current, power, solar irradiance, wind speed, etc. The sense device 304 may include a smart meter with multiple channels of measurement that may comprise single-phase circuits and/or three-phase circuits. The sense device 304 may communicate meter data back to the core device 302 from meter locations such as electrical rooms, rooftop solar installations, EV chargers, and subpanels. Certain aspects may be optimized for ease of installation and reduced intrusion to the site. Power over Ethernet (PoE) sourced from the core device 302 may suffice for most installations. The sense device 304 may transmit data back to the core device 302 via a network switch. The sense device 304 may be optimized to utilize minimal power, and PoE may be acceptable for most installations.

As illustrated in FIG. 4B, the sense device 304 includes one or more meters 414, one or more communication adapters 416, one or more network switches 418, one or more PAN coordinators 420, and/or one or more power supplies 422. The power supply(ies) 422 may include a power interface for providing power to the sense device 304. In certain aspects, the meter(s) 414 may be power meter(s) utilized for monitoring single-phase and three-phase loads of power. The communication adapter(s) 416 may be utilized for facilitating communications between the sense device 304 and other devices. The network switch(es) 418 may be a PoE enabled switch for communication. Similarly, the PAN coordinator(s) 420 may create and/or join personal area networks, such as via Zigbee, Bluetooth, and the like. In some aspects, PoE or other power source may be utilized.

As illustrated in FIG. 4C, the remote communications device 306 may be a network-connectivity extension, for example, for EV charging or solar monitoring locations where Zigbee, Wi-Fi, or Ethernet is being extended to remote or difficult-to-reach locations such as remote subpanels, parking garage levels, or rooftop inverters. Some aspects are optimized for ease of installation and reduced intrusion to the site where PoE may suffice for most installations from the core device 302. The remote communications device 306 may be configured to transmit data back to the core device 302 via a network switch.

Specifically, the remote communications device 306 may include one or more wireless access points 424, one or more communication adapters 426, one or more network switches 428, one or more PAN coordinators 430, and/or one or more power supplies 432. The wireless access point(s) 424 may be configured to extend wireless communication signals to chargers and/or other intelligent electronic devices. The communication adapter(s) 426 may be configured for facilitating communications between the remote communications device 306 and other devices. The network switch(es) 428 may be configured as a PoE Ethernet switch and/or other network switch for communicating with the core device 302. The PAN coordinator(s) 430 may be configured to create and/or join personal area networks, such as via Zigbee, Bluetooth, and the like. The power supply(ies) 432 may include a power interface for providing power to the remote communications device 306.

### Example Cloud Environment

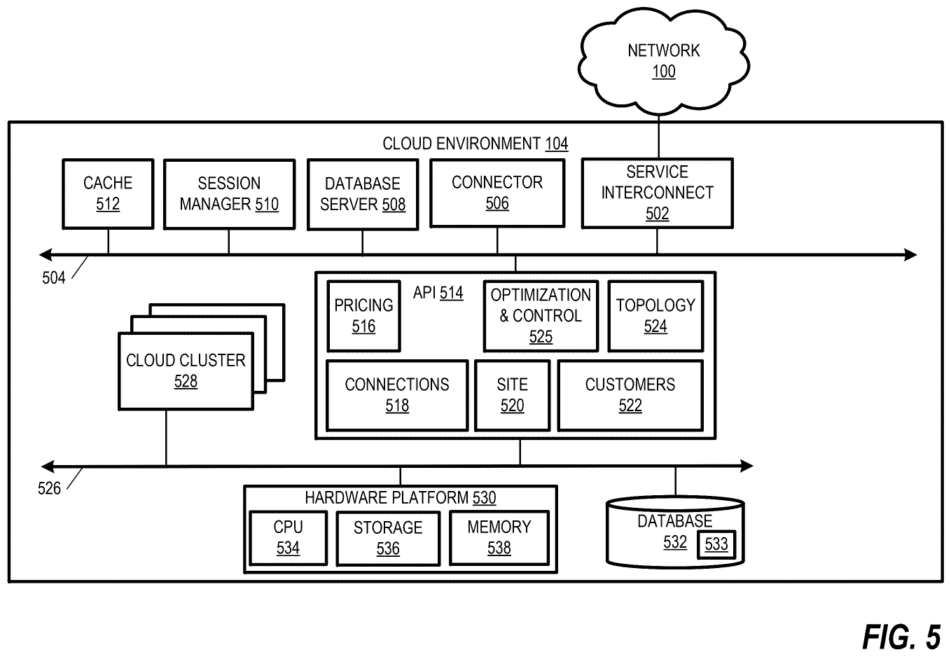

FIG. 5 depicts an example cloud environment which may interact with a site control system described herein. As illustrated, the network 100 may couple to the cloud environment 104 via a service interconnect 502 that corresponds with the service interconnect 224 from FIG. 2. Similar to the service interconnect 224 from FIG. 2, the service interconnect 502 may be configured to facilitate an HTTP, TCP, and/or other communication portal through the network 100 to the edge environment 102 for the exchange of data between the edge environment 102 and the cloud environment 104. Additionally or alternatively, the service interconnect 502 may be configured to facilitate an HTTP, TCP, and/or other communication portal through the network 100 directly with an electric vehicle supply equipment (EVSE), such as charging station 112, for the exchange of data between the edge environment 102 and the EVSE. For example, in some such aspects, cloud environment 104 may be configured with the same or similar components as edge environment 102 (e.g., in addition or alternative to one or more components shown in FIG. 5) and configured to perform functions similar to edge environment 102, such that a separate edge environment 102 may not be needed.

The service interconnect 502 is coupled to a communication bus 504, which facilitates communication among various components of FIG. 5. Also connected to the communication bus 504 are a NATS connector 506, a database server 508, a session manager 510, a cache 512, and a collection of services and application programming interfaces (APIs) 514. The APIs 514 may include a pricing API 516, a connections API 518, a site API 520, a customers API 522, a topology API 524, and/or an optimization and control API 525. The APIs 514 may be implemented by hardware platform 530. Hardware bus 526 is coupled to a NATS cloud cluster 528, as well as the hardware platform 530 and a database 532. The hardware platform 530 may include one or more CPUs 534, one or more storage components 536, and one or more memory components 538. Though certain components of cloud environment 104 are depicted separate from hardware platform 530, they may be services or processes configured to run on hardware platform 530. Further, though certain components are illustrated as separate components, the functionality of such components may be combined into a single component and/or further divided among additional components.

The APIs 514 is a component of the cloud environment 104. As such, the APIs 514 (including the pricing API 516, the connections API 518, the site API 520, the customers API 522, the topology API 524, and/or the optimization and control API 525) may cause storage of and/or process site information, site topology, customers, connections to panels, constraints of panels, pricing information of each site, local forecasting services, optimization services, controller services, caching services, etc. The APIs 514 may also serve as a mobile backend by storing personal information of charge users (e.g., email, charging preferences, payment preferences, privileges, access, fleet information, etc.). The APIs 514 may additionally store peak charging configurations, data related to meter setup, etc. In some cases, the APIs 514 may also be responsible for tracking changes to EVSE connections and causing related changes to various types of data. For example, a newly connecting EVSE may create a new charging session, and a newly disconnecting EVSE may close a charging session. The connection and the disconnection may cause changes in payment information for user(s) of the connecting or disconnecting EVSE(s), for example, related to payment for energy usage. In some aspects, the pricing API 516 may be used for storing information related to pricing configuration of a charging site, such as the site 110 (of FIG. 1). Some examples of the information related to pricing configuration of a charging site may include, but not be limited to, cost for energy (e.g., $/kWh), cost for parking time (e.g., $/time-interval), cost for idle parking time (e.g., $/idle-time-interval), etc. In certain aspects, the site API 520 may be or include a service that provides an API to read or change information about a charging site (e.g., site name, address, etc.). The topology API 524 may be used for storing information related to topology of EVSEs, and may be utilized to track, for example, which EVSEs are connected to which electrical panels and whether any electrical panels may be subpanels of other panels. Such information may be utilized for load management. In some aspects, the optimization and control API 525 may be responsible for handling optimization requests, performing one or more optimization methods, and communicating the result of the optimization. For example, the optimization and control API 525 may be or include a service that may be executed when there is a newly connected or disconnected EVSE, such that an optimization may be performed to allocate (e.g., re-allocate) power according to updated state(s) of the EVSE(s). In some aspects, optimization and control API 525 may enable per-site configuration of the optimization and control parameters. For example, these parameters can be updated via API(s) 514 (e.g., optimization and control API 525) directly or via a front-end interface. These parameters may include different parameters for each optimization strategy as well as the grouping of strategies into stages. Moreover, optimization and control API 525 may be used to store (e.g., via database 532) input and output pairs (e.g., related to various optimization scenarios, where an input may correspond to a combination of the optimization configuration and system state and an output may correspond to a collection of parameters for how the system should operate, etc.) for subsequent analysis. In some aspects, API(s) 514 (e.g., optimization and control API 525) may be used, at least in part, to obtain data relating to operational parameters (which may be an example of set points), such as optimized or initial operational parameters, for one or more site energy sources (e.g., a solar device 114b, a BESS 114c, and/or the like, as depicted in FIG. 1). One or more of such operational parameters may be sent to and adjusted (e.g., filtered) by, for example, the site controller component 236 of FIG. 2, such that the adjusted operational parameters may be sent to the one or more site energy sources.

When a vehicle is plugged into a charging station 112 (FIG. 1), the edge session broker 218 (FIG. 2) may communicate connection information to the APIs 514. The connection information may include vehicle information, user information, charging station information, etc. The APIs 514 then create a charge session object, which is stored in the cache 512. The cache 512 sends the session data, along with topology constraints and the charge session object to the edge environment 102. The NATS connector 506 may additionally cause the NATS cloud cluster 528 to maintain the charge session object for retrieval by an interested party. As the session continues, the session manager 510 may be utilized to alter constraints of the session, which may cause the NATS cloud cluster 528 to update the charge session object.

When a user claims a previously created session with the mobile device 108c, the database server 508 may create a database entry (e.g., within the database 532) with the charge session, driver, energy request, willingness to pay, electricity purchased, etc. The NATS connector 506 may update the NATS cloud cluster 528 with the database entry. This data may then be sent to the edge environment 102. When the charge session ends (e.g., when the vehicle is unplugged), that action may be added to the database entry and the database entry may be moved from a current sessions list to a completed sessions list.

In certain aspects, the database 532 may include optimization data 533 related to, for example, optimization scenarios (e.g., past optimization scenarios which may be used for debugging and/or auditing the performance of a given optimization scheme).

As indicated above, the hardware platform 530 may represent hardware that may be utilized to execute the components described regarding FIG. 5. As such, the CPU(s) 534 may be configured as any processing unit for receiving and executing computer-readable instructions. The storage component(s) 536 may be configured as any hard drive or other local storage device. The memory component(s) 538 may be configured as any type of RAM, ROM, registers, etc. or the like.

### Example Site Control Systems and Methods

Certain aspects of the present disclosure provide one or more solutions for the technical problems and issues associated with one or more grid limits described above. For example, some power networks do not have an inverter-agnostic solution for interconnection requirements for battery and solar projects. For some of such power networks, utility grid power import and export limits may be enforced via a protection relay or by inverter-specific Underwriters Laboratories (UL) listings (UL 1741 CRD and UL 3141). However, protection relays are costly, require a complex setup by relay engineers, and/or potentially reduce project up-time (e.g., since they send hard trips to distributed generators, including generator hardware or inverters, such as PV inverters, BESS inverters, PV/BESS breakers, etc.). Moreover, inverter-specific UL listings may pose an issue for developers and energy management programs since they are tied to specific inverter models (e.g., Original Equipment Manufacturer (OEM) models), thus potentially requiring more complex hardware design at each individual inverter.

Certain aspects provide a controller (e.g., a site controller) which may actively control site energy sources. For example, the site controller may rely on (e.g., digital) signals to (e.g., rapidly) limit power production or consumption of the site energy sources, rather than on the energy sources themselves (or their software) for limitation. This allows many types (e.g., any type) of energy source (e.g., manufactured by any manufacturer) to be used with the site controller described herein. Some aspects may expedite interconnection processes, for example, by having a product that could pass the requirements for UL 3141, satisfying common electrical utility requirements. Moreover, certain aspects may reduce system down-time (e.g., compared to systems that utilize protection relays), such as by utilizing active control of a site by leveraging fast-read protocols of power meters and limiting power of site energy sources accordingly. Furthermore, some aspects may enable inverter-agnostic grid-connection that could remove the need for protection relays such as non-export, limited-export, and/or non-import relays (e.g., as contrasted with some systems where grid limitation functionality may be embedded in the inverter itself, limiting flexibility to select desired BESS hardware for a site). Certain aspects may simplify and/or standardize grid limit enforcement by, for example, removing the need for complex project-specific designs (e.g., professional engineering solutions) and/or leveraging equipment that is used for battery energy storage projects (power generation projects).

Certain aspects utilize a (e.g., central) controller that reads power meters that monitor (e.g., all) site energy sources and PCCs (e.g., grid limitations). In some aspects, the central controller may be in a main enclosure that interfaces with peripheral power meters over communication protocols. In some aspects, the central controller may interface with site energy sources over serial protocol, and/or digital signals to a disconnect switch or device that would enforce a power limit of the energy sources. In some aspects, a continuous power limit may be calculated for each site energy source.

Certain aspects may actively limit the site energy sources that may be controlled and may enforce power limits to some or all site energy sources, regardless of whether they can be actively controlled or not.

Certain aspects may monitor BESS and PCC feeders, actively limit BESS and PV systems to be within grid limits, disable BESS when the system has operated outside grid limits for at least a threshold time period, or the like.

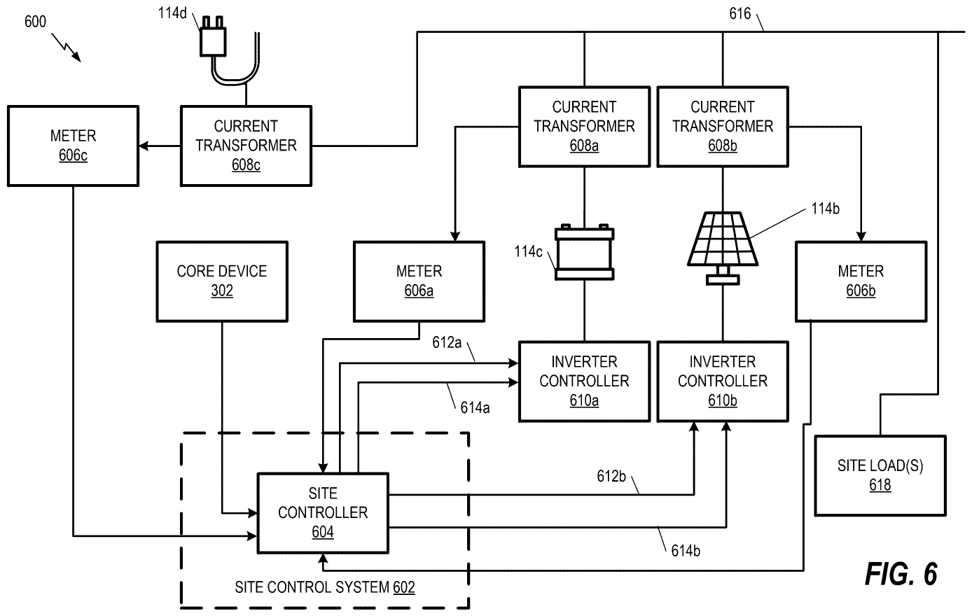

FIG. 6 depicts an example site environment 600 having a site control system 602 for grid interface power management. In certain aspects, the site control system 602 includes a site controller 604. The site controller 604 may be implemented by, for example, one or more components of the edge environment 102 of FIG. 2 (e.g., site controller component 236). As depicted, the site controller 604 is connected to a first meter 606a, a second meter 606b, and a third meter 606c. In certain aspects, the site controller 604 may obtain power measurements from the first meter 606a, the second meter 606b, and the third meter 606c. The first meter 606a may be used to measure the power measurement for BESS 114c via a first current transformer 608a. The second meter 606b may be used to measure the power measurement for solar device 114b (which may be a photovoltaic energy system) via a second current transformer 608b. The third meter 606c may be used to measure the power measurement for the PCC coupled to utility grid 114d, such as via a third current transformer 608c (where the PCC may be coupled to the third current transformer 608c as well as the utility grid 114d). The site environment 600 may connect certain ones of the components described above via bus 616, which may also be connected to other site load(s) 618, such as one or more EVSEs.

In certain aspects, the site controller 604 may obtain a plurality of power measurements from one or more site energy sources, such as the BESS 114c and/or the solar device 114b, and/or one or more PCCs such as the PCC coupled to the utility grid 114d and the third current transformer 608c. The one or more PCCs may correspond to one or more nodes where the one or more site energy sources are coupled to the utility grid 114d. Further, the site controller 604 may determine whether the plurality of power measurements (e.g., in combination, individually, etc.) violate (e.g., exceed) one or more grid limits (referred to as a grid limit for each of the site energy sources) of the utility grid 114d, such as for at least a threshold time period (e.g., 2 seconds). Examples of the grid limits include, without limitation, a minimum power import limit, a non-power export limit, a limited-power export limit, and/or a non-power import limit. In certain aspects, if one or more power measurements violate the grid limit, such as for at least a threshold time period, the site controller 604 may send a trip signal to at least one inverter controller associated with at least one site energy source. For example, the site controller 604 may send a trip signal 614a to an inverter controller 610a of the BESS 114c. As another example, the site controller 604 may send a trip signal 614b to an inverter controller 610b of the solar device 114b. Accordingly, the site controller 604 may send the trip signal 614a, 614b if a grid limit has been violated for at least the threshold time period. If the grid limit has not been violated for at least the threshold time period, the site controller 604 may not send the trip signal 614a, 614b.

In certain aspects, the site controller 604 may obtain, from core device 302, one or more operational parameters for one or more of the site energy sources. The site controller 604 may determine one or more adjusted (e.g., filtered) operational parameters for the one or more site energy sources based on the one or more operational parameters, a plurality of power measurements (which may be obtained from meters, such as the first meter 606a, the second meter 606b, and/or the third meter 606c, as described above), and a grid limit of the utility grid 114 d. For example, the site controller 604 may obtain one or more (e.g., optimized) set points as the one or more operational parameters for operating the one or more site energy sources. The site controller 604 may adjust or filter the obtained one or more operational parameters to determine the one or more adjusted operational parameters based on the one or more operational parameters, the plurality of power measurements, and the utility grid, such that the adjusted operational parameters may be adjusted from the one or more operational parameters as obtained from the core device 302 to meet the grid limit (e.g., for imported/exported energy to be within or below the grid limit such as to not violate the grid limit). The site controller 604 may send the adjusted operational parameters to the site energy sources, such as the BESS 114c and the solar device 114b (e.g., via control signals 612a, 612b, respectively).

Accordingly, the site controller 604 may actively control the power levels at various site energy sources in view of one or more grid limits, and/or send trip signals to the site energy sources if the site energy sources violate the one or more grid limits for at least a threshold time period (e.g., 2 seconds). In certain aspects, the site controller 604 may enable EV charging system, such as that including one or more of the components described herein, to pass a certification process associated with one or more grid limits.

In certain aspects, the site controller component 236 (of FIG. 2) may implement one or more functions of the site control system 602 (e.g., of the site controller 604) by utilizing one or more components of the edge environment 102 described herein (e.g., the optimization and control manager 203). In some aspects, the site control system 602 may utilize one or more components and/or compute resources of the edge environment 102. In certain aspects, the site controller component 236 and the site control system 602 may be implemented via different and/or separate hardware devices.

In some aspects, the site control system 602 may utilize data or information received (e.g., indirectly, through a core device 302) from one or more components of the cloud environment 104 to implement its functions. For example, one or more components of the cloud environment 104 may be used to set one or more initial operational parameters for one or more site energy sources. In real time, however, the site control system 602 may determine there is likely (e.g., within at least a threshold confidence) to be a grid limit violation, and accordingly, may modify those initial operational parameters (e.g., temporarily, as needed, etc.). Once the issue corresponding to a (e.g., likely) grid limit violation is no longer present (e.g., based on observed power measurements, such as for a length of time), the one or more site energy sources may be controlled or enabled to go back operating based on operational parameters as provided (e.g., indirectly, through a core device 302) by the cloud environment 104 (which may or may not be updated by the cloud environment 104 in the meantime).

FIG. 7 depicts an illustration relating to an example process flow for the site control system 602 for grid interface power management.

At 702, the site control system 602 may receive an input from power meters (e.g., meters 606a, 606b, 606c of FIG. 6). For example, the site control system 602 may receive active power from a solar device, a BESS, and/or a PCC via, for example, IEEE C37 Synchrophasor protocol or Modbus TCP Fast-read mode (<100 milliseconds (ms)).

At 704, a limit enforcer may start a timer for allowed threshold time period (e.g., a “non-adherence” limit) if a grid limit is violated or breached. In certain aspects, this timer may be used for determining whether the power measurements violate a grid limit for at least a threshold time period, such as described herein with respect to FIG. 6.

At 706, if the grid limit is violated or breached for longer than the allowed threshold time period, a trip signal may be sent to one or more site energy sources, such that the grid limit may no longer be violated. In certain aspects, such a trip signal may be an example of the trip signal 614a, 614b described herein with respect to FIG. 6. This may be an inverter-agnostic way to ensure that the grid limit is not violated or breached for longer than the allowed threshold time period (e.g., potentially satisfying a certification requirement associated with the grid limit).

At 708, a limit calculator may calculate power limit for one or more (e.g., all) site energy sources (e.g., at all times). In certain aspects, such a calculator may be used for operating or controlling the site energy sources in a manner that does not violate a grid limit. For example, the calculator may be used to provide power limits used for setting operational parameters of the site energy sources (e.g., to be within or below the calculated power limits).

At 710, a limit filter may use the calculated power limits to filter or adjust operational parameters (e.g., set points, received from a core device at 712) associated with the site energy sources.

At 714, the filtered or adjusted operational parameters may be sent to the site energy sources. For example, the site energy sources may be configured to operate based on the filtered or adjusted operational parameters.

At 716, the filtered or adjusted operational parameters, as well as other data or measurements obtained by the site control system 602 (e.g., power measurements obtained from meters 606a, 606b, 606c), may be sent to the core device for further use by the core device. For example, the core device 302 (of FIGS. 3A, 3B, or 3C) may use such information for management of a charging site.

At 718, the filtered or adjusted operational parameters and any relevant data from certain site energy sources, such as distributed generator(s), may be sent to the core device for further use by the core device. For example, the core device 302 (of FIGS. 3A, 3B, or 3C) may use such information for management of a charging site.

For example, in certain aspects, site control system 602 may be configured, based on determining that a grid limit may be violated in the future, or has been violated, but not yet violated for at least a threshold time period, to first send the filtered or adjusted operational parameters to the site energy sources, such as at 714. Site control system 602 may determine that the grid limit then has been violated, such as for at least the threshold time period, such as due to the filtered or adjusted operational parameters taking time to adjust operations of the site energy sources, and accordingly provide the trip output, such as at 706.

### Example Methods for Site Control for Grid Interface Power Management

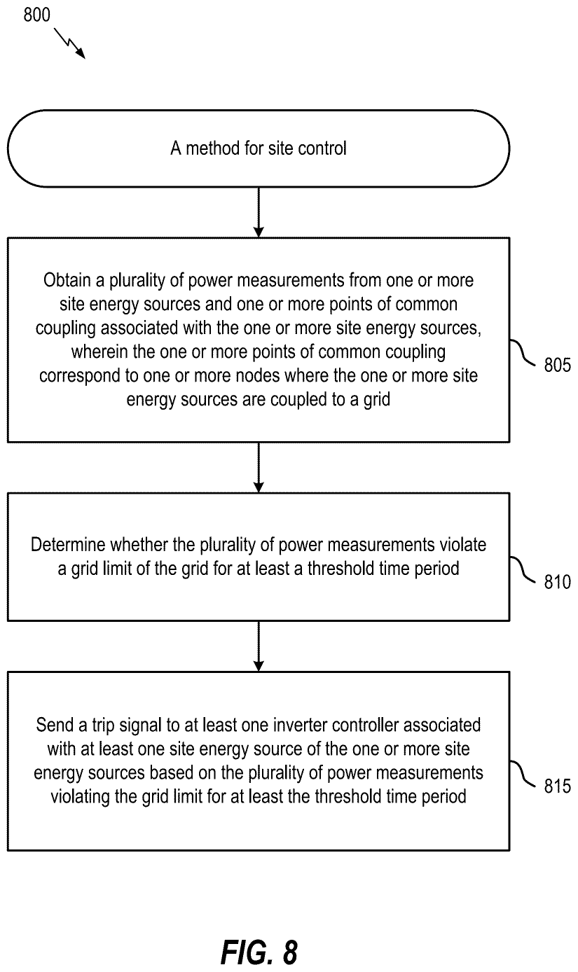

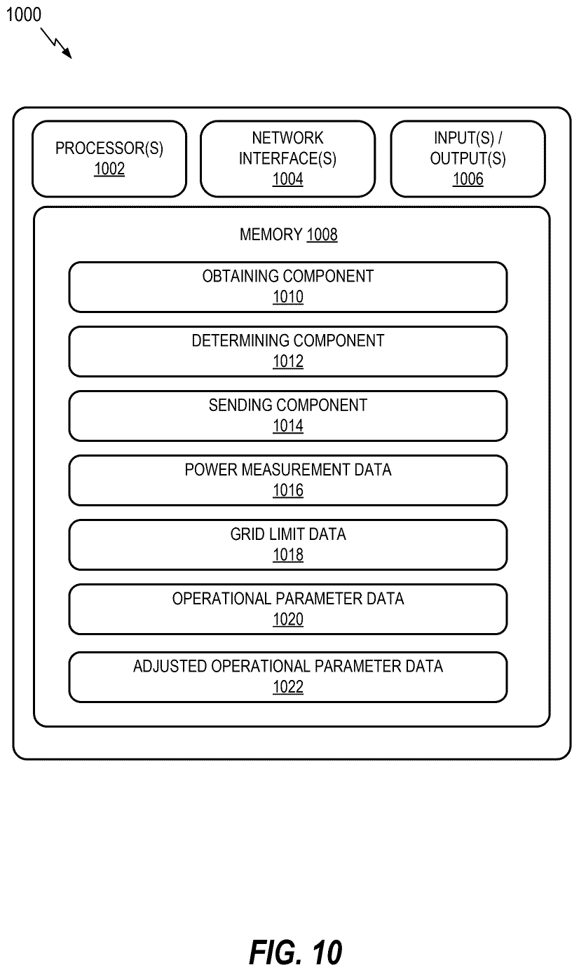

FIG. 8 depicts an example flowchart illustrating a method 800 for site control (e.g., for grid interface power management), according to aspects provided herein. The method 800 may be performed by site control system 602 of FIG. 6, for example, by utilizing one or more components of edge environment 102 described herein with respect to FIG. 2. In some aspects, the method 800 may be performed by an apparatus or a processing system, for example, by utilizing one or more components of processing system 1000 described herein with respect to FIG. 10.

Method 800 begins at block 805 with obtaining a plurality of power measurements from one or more site energy sources and one or more points of common coupling associated with the one or more site energy sources, wherein the one or more points of common coupling correspond to one or more nodes where the one or more site energy sources are coupled to a grid, such as described with respect to FIG. 6 or 7.

Method 800 then proceeds to block 810 with determining whether the plurality of power measurements violate a grid limit of the grid for at least a threshold time period, such as described with respect to FIG. 6 or 7.

Method 800 then proceeds to block 815 with sending a trip signal to at least one inverter controller associated with at least one site energy source of the one or more site energy sources based on the plurality of power measurements violating the grid limit for at least the threshold time period, such as described with respect to FIG. 6 or 7.

In some aspects, the one or more site energy sources comprise one or more of: a battery energy storage system; a photovoltaic energy system; a wind energy system; or a hydro energy system.

In some aspects, the grid limit comprises at least one of: a minimum power import limit; a non-power export limit; a limited-power export limit; or a non-power import limit.

In some aspects, method 800 further includes obtaining one or more operational parameters for the one or more site energy sources.

In some aspects, method 800 further includes determining one or more adjusted operational parameters for the one or more site energy sources based on the one or more operational parameters, the plurality of power measurements, and the grid limit.

In some aspects, method 800 further includes sending the one or more adjusted operational parameters to the one or more site energy sources.

In some aspects, obtaining the plurality of power measurements from the one or more site energy sources and the one or more points of common coupling includes obtaining the plurality of power measurements from one or more meters coupled to the one or more site energy sources and one or more meters coupled to the one or more points of common coupling.

In some aspects, obtaining the plurality of power measurements from the one or more meters coupled to the one or more site energy sources and the one or more meters coupled to the one or more points of common coupling includes communicating with the one or more meters coupled to the one or more site energy sources and the one or more meters coupled to the one or more points of common coupling via one or more fast-read protocols.

In some aspects, obtaining the plurality of power measurements from the one or more meters coupled to the one or more site energy sources and the one or more meters coupled to the one or more points of common coupling includes communicating with the one or more meters coupled to the one or more site energy sources and the one or more meters coupled to the one or more points of common coupling without communicating through a protection relay.

In certain aspects, method 800 enables sending a trip signal to any site energy source the site controller determines is in violation of a grid limit (e.g., is in violation of the grid limit for at least a threshold time period, such as 2 seconds). Based on the trip signal, the site energy source, such as an inverter of the site energy source, may stop importing or exporting any energy, such that the import power level and/or export power level is zero. Such trip signal, therefore, may provide the advantage of a fail-safe to avoid long-term violations of a grid limit, such as when setting operational parameters for a site energy source may take longer to take effect to bring power levels below the grid limit.

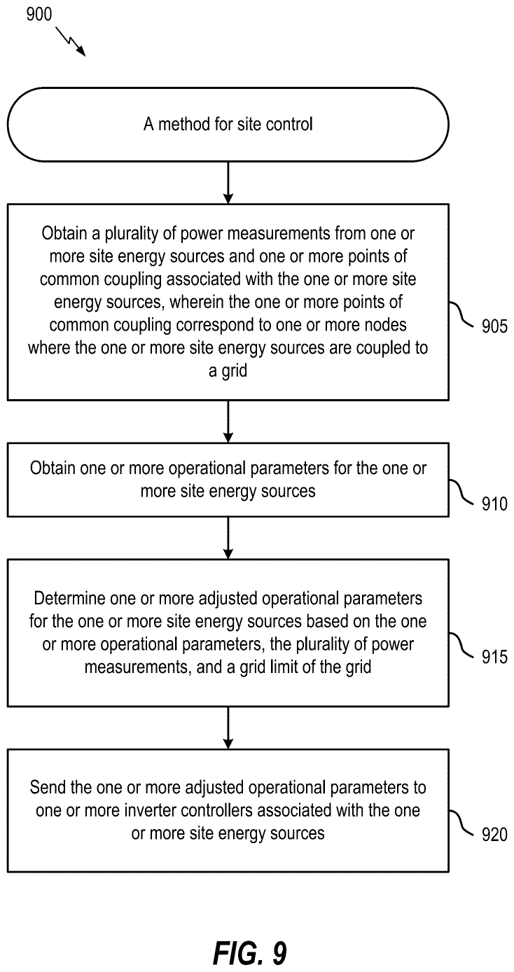

FIG. 9 depicts an example flowchart illustrating a method 900 for site control (e.g., for grid interface power management), according to aspects provided herein. The method 900 may be performed by site control system 602 of FIG. 6, for example, by utilizing one or more components of edge environment 102 described herein with respect to FIG. 2. In some aspects, the method 900 may be performed by an apparatus or a processing system, for example, by utilizing one or more components of processing system 1000 described herein with respect to FIG. 10.

Method 900 begins at block 905 with obtaining a plurality of power measurements from one or more site energy sources and one or more points of common coupling associated with the one or more site energy sources, wherein the one or more points of common coupling correspond to one or more nodes where the one or more site energy sources are coupled to a grid, such as described with respect to FIG. 6 or 7.

Method 900 then proceeds to block 910 with obtaining one or more operational parameters for the one or more site energy sources, such as described with respect to FIG. 6 or 7.

Method 900 then proceeds to block 915 with determining one or more adjusted operational parameters for the one or more site energy sources based on the one or more operational parameters, the plurality of power measurements, and a grid limit of the grid, such as described with respect to FIG. 6 or 7.

Method 900 then proceeds to block 920 with sending the one or more adjusted operational parameters to one or more inverter controllers associated with the one or more site energy sources, such as described with respect to FIG. 6 or 7.

In some aspects, obtaining the plurality of power measurements from the one or more site energy sources and the one or more points of common coupling includes obtaining the plurality of power measurements from one or more meters coupled to the one or more site energy sources and one or more meters coupled to the one or more points of common coupling.

In some aspects, obtaining the plurality of power measurements from the one or more meters coupled to the one or more site energy sources and the one or more meters coupled to the one or more points of common coupling includes communicating with the one or more meters coupled to the one or more site energy sources and the one or more meters coupled to the one or more points of common coupling via one or more fast-read protocols.

In some aspects, obtaining the plurality of power measurements from the one or more meters coupled to the one or more site energy sources and the one or more meters coupled to the one or more points of common coupling includes communicating with the one or more meters coupled to the one or more site energy sources and the one or more meters coupled to the one or more points of common coupling without communicating through a protection relay.

In some aspects, block 915 includes determining the one or more adjusted operational parameters to prevent violating the grid limit.

In some aspects, method 900 further includes determining, after the one or more adjusted operational parameters are sent, the grid limit is violated for at least a threshold time period.

In some aspects, method 900 further includes sending, based on the determination of the grid limit being violated for at least the threshold time period, a trip signal to at least one inverter controller associated with at least one site energy source of the one or more site energy sources.

In some aspects, the one or more site energy sources comprise one or more of: a battery energy storage system; a photovoltaic energy system; a wind energy system; or a hydro energy system.

In some aspects, the grid limit comprises at least one of: a minimum power import limit; a non-power export limit; a limited-power export limit; or a non-power import limit.

In certain aspects, method 900 enables determining whether based on the power measurements, a grid limit violation has occurred, or may be likely to occur. For example, the site controller may determine current operational parameters (e.g., charge rate, discharge rate, energy production rate, duty cycle, on duration, off duration, etc.) for a site energy source, and determine that if the site energy source continues to operate based on the current operational parameters, in view of the current power measurements, a grid limit violation will occur. Accordingly, the site controller may adjust the operational parameters (e.g., reduce power output level) for the site energy source, and send the adjusted operational parameters to the site energy source (e.g., an inverter of the site energy source, which may be controlled by an inverter controller) to avoid the grid limit violation. This may provide a technical solution to the technical problem of how to avoid a grid limit violation, such as without the complexity of a protection relay design discussed above.

### Example Processing System for Site Control

FIG. 10 depicts an example processing system 1000 configured to perform the methods described herein.

Processing system 1000 may include one or more processors 1002. Generally, the one or more processors 1002 may be configured to execute computer-executable instructions (e.g., software code) to perform various functions, as described herein.

Processing system 1000 may further include one or more network interfaces 1004, which generally provide data access to any sort of data network, including personal area networks (PANs), local area networks (LANs), wide area networks (WANs), the internet, and the like.

Moreover, processing system 1000 may include input(s) and output(s) 1006, which generally provide means for providing data to and from processing system 1000, such as via connection to computing device peripherals, including user interface peripherals.

Processing system 1000 may also include one or more memories 1008 comprising various components. In this example, the one or more memories 1008 may include obtaining component 1010, determining component 1012, and sending component 1014.

In certain aspects, obtaining component 1010 is configured to obtain a plurality of power measurements from one or more site energy sources and one or more points of common coupling associated with the one or more site energy sources (e.g., power measurement data 1016), wherein the one or more points of common coupling correspond to one or more nodes where the one or more site energy sources are coupled to a grid, for example, as described with reference to block 805 of FIG. 8. In certain aspects, determining component 1012 is configured to determine whether the plurality of power measurements violate a grid limit of the grid for at least a threshold time period (e.g., grid limit data 1018), for example, as described with reference to block 810 of FIG. 8. In certain aspects, sending component 1014 is configured to send a trip signal to at least one inverter controller associated with at least one site energy source of the one or more site energy sources based on the plurality of power measurements violating the grid limit for at least the threshold time period, for example, as described with reference to block 815 of FIG. 8.

In certain aspects, obtaining component 1010 is configured to obtain a plurality of power measurements from one or more site energy sources and one or more points of common coupling associated with the one or more site energy sources (e.g., power measurement data 1016), wherein the one or more points of common coupling correspond to one or more nodes where the one or more site energy sources are coupled to a grid, for example, as described with reference to block 905 of FIG. 9. In certain aspects, obtaining component 1010 is configured to obtain one or more operational parameters (e.g., operational parameter data 1020) for the one or more site energy sources, for example, as described with reference to block 910 of FIG. 9. In certain aspects, determining component 1012 is configured to determine one or more adjusted operational parameters (e.g., adjusted operational parameter data 1022) for the one or more site energy sources based on the one or more operational parameters, the plurality of power measurements, and a grid limit of the grid, as described with reference to block 915 of FIG. 9. In certain aspects, sending component 1014 is configured to send the one or more adjusted operational parameters to one or more inverter controllers associated with the one or more site energy sources, for example, as described with reference to block 920 of FIG. 9.

Processing system 1000 may be implemented in various ways. For example, processing system 1000 may be implemented as a computing device 402 within a core device 302, described herein with respect to FIGS. 3A-3C and 4A. In various aspects, one or more aspects may be omitted from, added to, or substituted from processing system 1000.

### Example Clauses

Implementation examples are described in the following numbered clauses:
Clause 1: A method for site control, comprising: obtaining a plurality of power measurements from one or more site energy sources and one or more points of common coupling associated with the one or more site energy sources, wherein the one or more points of common coupling correspond to one or more nodes where the one or more site energy sources are coupled to a grid; determining whether the plurality of power measurements violate a grid limit of the grid for at least a threshold time period; and sending a trip signal to at least one inverter controller associated with at least one site energy source of the one or more site energy sources based on the plurality of power measurements violating the grid limit for at least the threshold time period.
Clause 2: The method in accordance with Clause 1, wherein the one or more site energy sources comprise one or more of: a battery energy storage system; a photovoltaic energy system; a wind energy system; or a hydro energy system.
Clause 3: The method in accordance with any one of Clauses 1-2, wherein the grid limit comprises at least one of: a minimum power import limit; a non-power export limit; a limited-power export limit; or a non-power import limit.
Clause 4: The method in accordance with any one of Clauses 1-3, further comprising:
obtaining one or more operational parameters for the one or more site energy sources; determining one or more adjusted operational parameters for the one or more site energy sources based on the one or more operational parameters, the plurality of power measurements, and the grid limit; and
sending the one or more adjusted operational parameters to the one or more site energy sources.
Clause 5: The method in accordance with any one of Clauses 1-4, wherein obtaining the plurality of power measurements from the one or more site energy sources and the one or more points of common coupling comprises obtaining the plurality of power measurements from one or more meters coupled to the one or more site energy sources and one or more meters coupled to the one or more points of common coupling.
Clause 6: The method in accordance with Clause 5, wherein obtaining the plurality of power measurements from the one or more meters coupled to the one or more site energy sources and the one or more meters coupled to the one or more points of common coupling comprises communicating with the one or more meters coupled to the one or more site energy sources and the one or more meters coupled to the one or more points of common coupling via one or more fast-read protocols.
Clause 7: The method in accordance with Clause 5, wherein obtaining the plurality of power measurements from the one or more meters coupled to the one or more site energy sources and the one or more meters coupled to the one or more points of common coupling comprises communicating with the one or more meters coupled to the one or more site energy sources and the one or more meters coupled to the one or more points of common coupling without communicating through a protection relay.
Clause 8: A method for site control, comprising: obtaining a plurality of power measurements from one or more site energy sources and one or more points of common coupling associated with the one or more site energy sources, wherein the one or more points of common coupling correspond to one or more nodes where the one or more site energy sources are coupled to a grid; obtaining one or more operational parameters for the one or more site energy sources; determining one or more adjusted operational parameters for the one or more site energy sources based on the one or more operational parameters, the plurality of power measurements, and a grid limit of the grid; and sending the one or more adjusted operational parameters to one or more inverter controllers associated with the one or more site energy sources.
Clause 9: The method in accordance with Clause 8, wherein obtaining the plurality of power measurements from the one or more site energy sources and the one or more points of common coupling comprises obtaining the plurality of power measurements from one or more meters coupled to the one or more site energy sources and one or more meters coupled to the one or more points of common coupling.
Clause 10: The method in accordance with Clause 9, wherein obtaining the plurality of power measurements from the one or more meters coupled to the one or more site energy sources and the one or more meters coupled to the one or more points of common coupling comprises communicating with the one or more meters coupled to the one or more site energy sources and the one or more meters coupled to the one or more points of common coupling via one or more fast-read protocols.
Clause 11: The method in accordance with Clause 9, wherein obtaining the plurality of power measurements from the one or more meters coupled to the one or more site energy sources and the one or more meters coupled to the one or more points of common coupling comprises communicating with the one or more meters coupled to the one or more site energy sources and the one or more meters coupled to the one or more points of common coupling without communicating through a protection relay.
Clause 12: The method in accordance with any one of Clauses 8-11, wherein determining the one or more adjusted operational parameters comprises determining the one or more adjusted operational parameters to prevent violating the grid limit.
Clause 13: The method in accordance with any one of Clauses 8-12, further comprising: determining, after the one or more adjusted operational parameters are sent, the grid limit is violated for at least a threshold time period; and sending, based on the determination of the grid limit being violated for at least the threshold time period, a trip signal to at least one inverter controller associated with at least one site energy source of the one or more site energy sources.
Clause 14: The method in accordance with any one of Clauses 8-13, wherein the one or more site energy sources comprise one or more of: a battery energy storage system; a photovoltaic energy system; a wind energy system; or a hydro energy system.
Clause 15: The method in accordance with any one of Clauses 8-14, wherein the grid limit comprises at least one of: a minimum power import limit; a non-power export limit; a limited-power export limit; or a non-power import limit.

Clause 16: A site controller comprising: one or more memories; and one or more processors, coupled to the one or more memories, configured to cause the site controller to perform a method in accordance with any one of Clauses 1-15.

Clause 17: One or more apparatuses, comprising means for performing a method in accordance with any one of Clauses 1-15.

Clause 18: A processing system, comprising means for performing a method in accordance with any one of Clauses 1-15.

Clause 19: A processing system, comprising: one or more memories comprising computer-executable instructions; and one or more processors configured to execute the computer-executable instructions and cause the processing system to perform a method in accordance with any one of Clauses 1-15.

Clause 20: A non-transitory computer-readable medium comprising computer-executable instructions that, when executed by a processor of a processing system, cause the processing system to perform a method in accordance with any one of Clauses 1-15.

Clause 21: A computer program product embodied on a computer-readable storage medium comprising code for performing a method in accordance with any one of Clauses 1-15.

Clause 22: A processing system, comprising: one or more memories; and one or more processors, coupled to the one or more memories, configured to cause the processing system to perform a method in accordance with any one of clauses 1-15.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) (logic) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a memory,” “the processor,” “the memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., a system) to perform functions, one element may be configured to cause the other element to perform all functions, or more than one element may collectively be configured to cause the other element to perform the functions. Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

While particular aspects and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the aspects shown and described herein.

What is claimed is:

1. A site controller, comprising:
one or more memories; and
one or more processors, coupled to the one or more memories, configured to cause the site controller to:
obtain a plurality of power measurements from one or more site energy sources and one or more points of common coupling associated with the one or more site energy sources, wherein the one or more points of common coupling correspond to one or more nodes where the one or more site energy sources are coupled to a grid;
determine whether the plurality of power measurements violate a grid limit of the grid for at least a threshold time period; and
send a trip signal to at least one inverter controller associated with at least one site energy source of the one or more site energy sources based on the plurality of power measurements violating the grid limit for at least the threshold time period.

2. The site controller of claim 1, wherein the one or more site energy sources comprise one or more of:
a battery energy storage system;
a photovoltaic energy system;
a wind energy system; or
a hydro energy system.

3. The site controller of claim 1, wherein the grid limit comprises at least one of:
a minimum power import limit;
a non-power export limit;
a limited-power export limit; or
a non-power import limit.

4. The site controller of claim 1, wherein the one or more processors are further configured to cause the site controller to:
obtain one or more operational parameters for the one or more site energy sources;
determine one or more adjusted operational parameters for the one or more site energy sources based on the one or more operational parameters, the plurality of power measurements, and the grid limit; and
send the one or more adjusted operational parameters to the one or more site energy sources.

5. The site controller of claim 1, wherein to cause the site controller to obtain the plurality of power measurements from the one or more site energy sources and the one or more points of common coupling, the one or more processors are configured to cause the site controller to obtain the plurality of power measurements from one or more meters coupled to the one or more site energy sources and one or more meters coupled to the one or more points of common coupling.

6. The site controller of claim 5, wherein to cause the site controller to obtain the plurality of power measurements from the one or more meters coupled to the one or more site energy sources and the one or more meters coupled to the one or more points of common coupling, the one or more processors are configured to cause the site controller to communicate with the one or more meters coupled to the one or more site energy sources and the one or more meters coupled to the one or more points of common coupling via one or more fast-read protocols.

7. The site controller of claim 5, wherein to cause the site controller to obtain the plurality of power measurements from the one or more meters coupled to the one or more site energy sources and the one or more meters coupled to the one or more points of common coupling, the one or more processors are configured to cause the site controller to communicate with the one or more meters coupled to the one or more site energy sources and the one or more meters coupled to the one or more points of common coupling without communicating through a protection relay.

8. A site controller, comprising:
one or more memories; and
one or more processors, coupled to the one or more memories, configured to cause the site controller to:
obtain a plurality of power measurements from one or more site energy sources and one or more points of common coupling associated with the one or more site energy sources, wherein the one or more points of common coupling correspond to one or more nodes where the one or more site energy sources are coupled to a grid;
obtain one or more operational parameters for the one or more site energy sources;
determine one or more adjusted operational parameters for the one or more site energy sources based on the one or more operational parameters, the plurality of power measurements, and a grid limit of the grid; and
send the one or more adjusted operational parameters to one or more inverter controllers associated with the one or more site energy sources.

9. The site controller of claim 8, wherein to cause the site controller to obtain the plurality of power measurements from the one or more site energy sources and the one or more points of common coupling, the one or more processors are configured to cause the site controller to obtain the plurality of power measurements from one or more meters coupled to the one or more site energy sources and one or more meters coupled to the one or more points of common coupling.

10. The site controller of claim 9, wherein to cause the site controller to obtain the plurality of power measurements from the one or more meters coupled to the one or more site energy sources and the one or more meters coupled to the one or more points of common coupling, the one or more processors are configured to cause the site controller to communicate with the one or more meters coupled to the one or more site energy sources and the one or more meters coupled to the one or more points of common coupling via one or more fast-read protocols.

11. The site controller of claim 9, wherein to cause the site controller to obtain the plurality of power measurements from the one or more meters coupled to the one or more site energy sources and the one or more meters coupled to the one or more points of common coupling, the one or more processors are configured to cause the site controller to communicate with the one or more meters coupled to the one or more site energy sources and the one or more meters coupled to the one or more points of common coupling without communicating through a protection relay.

12. The site controller of claim 8, wherein to cause the site controller to determine the one or more adjusted operational parameters, the one or more processors are configured to cause the site controller to determine the one or more adjusted operational parameters to prevent violating the grid limit.

13. The site controller of claim 8, wherein the one or more processors are further configured to cause the site controller to:
after the one or more adjusted operational parameters are sent, determine the grid limit is violated for at least a threshold time period; and
based on the determination of the grid limit being violated for at least the threshold time period, send a trip signal to at least one inverter controller associated with at least one site energy source of the one or more site energy sources.

14. The site controller of claim 8, wherein the one or more site energy sources comprise one or more of:
a battery energy storage system;
a photovoltaic energy system;
a wind energy system; or
a hydro energy system.

15. The site controller of claim 8, wherein the grid limit comprises at least one of:
a minimum power import limit;
a non-power export limit;
a limited-power export limit; or a non-power import limit.

16. A method for site control, comprising:
obtaining a plurality of power measurements from one or more site energy sources and one or more points of common coupling associated with the one or more site energy sources, wherein the one or more points of common coupling correspond to one or more nodes where the one or more site energy sources are coupled to a grid;
obtaining one or more operational parameters for the one or more site energy sources;
determining one or more adjusted operational parameters for the one or more site energy sources based on the one or more operational parameters, the plurality of power measurements, and a grid limit of the grid; and
sending the one or more adjusted operational parameters to one or more inverter controllers associated with the one or more site energy sources.

17. The method of claim 16, wherein determining the one or more adjusted operational parameters comprises determining the one or more adjusted operational parameters to prevent violating the grid limit.

18. The method of claim 16, wherein obtaining the plurality of power measurements from the one or more site energy sources and the one or more points of common coupling comprises obtaining the plurality of power measurements from one or more meters coupled to the one or more site energy sources and one or more meters coupled to the one or more points of common coupling.

19. The method of claim 18, wherein obtaining the plurality of power measurements from the one or more meters coupled to the one or more site energy sources and the one or more meters coupled to the one or more points of common coupling comprises communicating with the one or more meters coupled to the one or more site energy sources and the one or more meters coupled to the one or more points of common coupling via one or more fast-read protocols.

20. The method of claim 18, wherein obtaining the plurality of power measurements from the one or more meters coupled to the one or more site energy sources and the one or more meters coupled to the one or more points of common coupling comprises communicating with the one or more meters coupled to the one or more site energy sources and the one or more meters coupled to the one or more points of common coupling without communicating through a protection relay.
